(19) United States
(12) Patent Application Publication
(10) Pub. No.: US 2008/0316045 A1
(43) Pub. Date: Dec. 25, 2008

(54) Intelligent medical material cart

(75) Inventors: Timur P Sriharto, Monroeville, PA (US); Muhammad Rahim Rahim, Monroeville, PA (US); Suneil Mandava, Pittsburgh, PA (US); Pribadi Kardono, Monroeville, PA (US); Khang Le, Pittsburgh, PA (US)

Correspondence Address: Ashok Tankha;Lipton, Weinberger & Husick, 36 Greenleigh Drive, Sewell, NJ, 08080, US

(73) Assignee: Mobile Aspects, Pittsburgh, PA (US)

(21) Appl. No.: 11/820,663

(22) Filed: Jun. 20, 2007

(51) Int. Cl. G06Q 50/00

(52) U.S. Cl. 340/825.49; 700/214; 705/2; 705/3

(57) ABSTRACT

A method and system is disclosed for monitoring, control and containment of medical product in a healthcare facility. The physical coordinates of the intelligent medical material cart (IMMC) within the healthcare facility are determined. Based on the physical coordinates of the IMMC, the room and the identity of the patient being operated within the room are determined. The electronic medical records of the identified patient are accessed. The IMMC is accessed by the healthcare staff for the medical product stored within the IMMC. The IMMC determines the identity of the medical product that has been removed from the IMMC based on radio frequency identification (RFID) mechanism. The IMMC also determines the effect of interaction of the drugs on the patient, by referring to the medical profile of the patient in the electronic medical records. An alarm is set off if an adverse interaction of medical product is anticipated.

### BACKGROUND

This invention, in general, relates to a method and system for monitoring, control, and containment of a material, and specifically relates to a method and system for monitoring, control, and containment of a medical product comprising a drug, a non-drug, and a medical product in a hospital environment.

Medication errors in patient care pose significant risks to patient safety and are a common cause of death and disability. The use of a wrong drug name, incorrect dosage form, mistaken abbreviation, failure to administer a prescribed medication, error in calculation of dosage and improper combination of drugs can cause irreparable harm to patients.

The problems stated above are compounded in the fast-paced or emergency environment in an operation theater of a hospital. In such an environment, where decisions need to be taken in real-time, and with little time available for careful analysis, a variety of drug administration errors may occur. Emergency situations accentuate these problems as emergency procedures involve a rapid response or a quick set up, consequently affording less time for timely and accurate record keeping, drug dispensing, etc. For example, medication errors may include use of drugs the patient is allergic to, incorrect medication, wrong dosage of the correct medication, and correct dosage of the correct medication but administration of the drug at the wrong time.

Health care delivery institutions, such as hospitals control a large amount of inventory in their system. Hundreds of items and products move in and out of supply and operating rooms everyday, and there is a need for system administrators to be sure to know exactly what items or products are being used, when they are being used, who is using them, and the frequency at which such items or products are being used. At all times, items must be accounted for, and must be fully stocked. Manual control or intervention in drug supply and administration in the item or drug supply chain increases the likelihood of causing errors.

When a medical product is used during an operation, the nurse or clinician usually removes it from the central or peripheral supply room and records its use on paper. Typically there is minimal accountability as to what has been taken, who took it, and how many of the items or products were taken. In many instances, a nurse must manually record every item that is being used. The information is only as accurate as to what has been recorded. During busy times, the information garnered is inaccurate or the entire process is sometimes skipped.

In summary, the current method of monitoring of drug administration, controlling and containment of medical products in an operation theatre or a hospital environment is prone to error and imprecise.

### SUMMARY OF THE INVENTION

Disclosed herein is a method and system for monitoring, control and containment of medical material in an operation theatre in a healthcare facility. The physical coordinates of the intelligent medical material cart (IMMC) within the healthcare facility are determined using a position determination unit. Based on the physical coordinates of the IMMC, the room and the identity of the patient being requiring the medical item or product in a room are determined. The electronic medical records of the identified patient are accessed. The IMMC is accessed by the healthcare staff for the drugs stored within the IMMC. The IMMC determines the identity of the drug that has been removed from the IMMC based on a radio frequency identification (RFID) mechanism and records the time at which a item or drug is removed from the IMMC. The IMMC also determines the effect of interaction of the drugs on the patient, by checking with the medical profile of the patient in the electronic medical records. The effects of an adverse or other drug interaction are displayed on a display unit of the IMMC or anywhere within the healthcare facility using a network, along with other pertinent medical information. An alarm is set off on the IMMC or anywhere within the healthcare facility using a network, if an adverse drug interaction is indicated or anticipated. The IMMC is capable of accurately inventorying its entire contents, as well as any individual drug item in the medical container.

In another embodiment of the invention, the RFID tags may also be affixed to the medical apparatuses and the staff working in the hospital.

In another embodiment of the invention, the IMMC checks the patient's electronic medical records to determine whether a drug being removed from the IMMC for administration to the patient has any adverse interaction with a drug previously administered to the patient.

In another embodiment of the invention, the IMMC enunciates an alarm if the drug name read by the RFID tag does not match with the drug name prescribed or scheduled to be taken out of the IMMC and administered to the patient.

Another embodiment of the invention ensures the availability of drugs in real time in a medical operation theatre using the IMMC.

In another embodiment of the invention, the IMMC sends a warning notice to the physician using an alarm on the IMMC, and to the pharmacy using a network, if a drug stored in the IMMC is past its expiry date or may adversely interact with a previously administered drug to the patient.

### BRIEF DESCRIPTION OF THE DRAWINGS

The foregoing summary, as well as the following detailed description of the embodiments, is better understood when read in conjunction with the appended drawings. For the purpose of illustrating the invention, there is shown in the drawings exemplary constructions of the invention; however, the invention is not limited to the specific methods and instrumentalities disclosed.

FIG. 1 exemplarily illustrates a system architecture for the implementation of the intelligent medical material cart (IMMC).

FIG. 2 illustrates an exemplary representation of the intelligent medical material cart (IMMC).

FIG. 3 exemplarily illustrates the method of monitoring, control and containment of medical materials in an operation theatre in a healthcare facility.

### DETAILED DESCRIPTION OF THE DRAWINGS

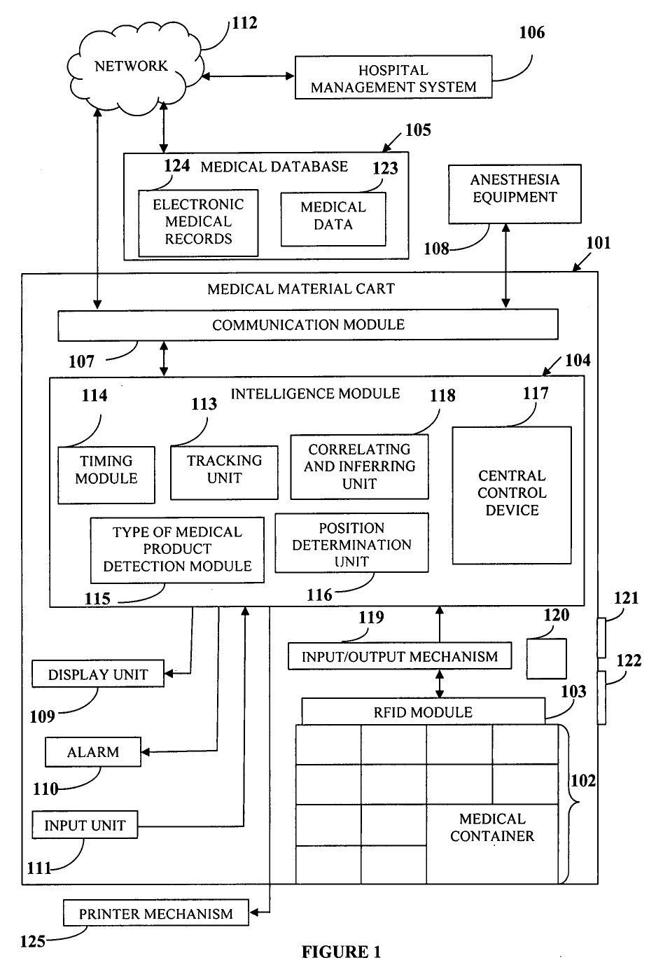

FIG. 1 illustrates an exemplary system architecture for implementing the intelligent medical material cart (IMMC) 101. The IMMC 101 is a mobile cart that transports medical supplies to the operation theatres or to any other location in a healthcare facility, and performs a multitude of intelligence functions such as monitoring its contents, controlling access to its contents, monitoring the drug administrations, determining patient-drug interactions, determining drug-drug interactions, identifying adverse drug interactions, etc.

The enclosed medical container 102 with a cover housed within the IMMC 101 contains multiple receptacles, which are accessible to a user. The receptacles hold a plurality of dissimilar medical products. The receptacle could be a drawer 201, a shelf, a box, a container, etc. The IMMC 101 comprises an intelligence module 104 that tracks and monitors the contents of the IMMC 101, controls access to the IMMC 101, infers patient-drug interactions, indicates and alarms negative patient-drug interactions, etc. The intelligence module 104 comprises a position determination unit 116, a central control device 117, a timing module 114, a tracking unit 113, a correlating and inferring unit 118, and a “type of medical product” detection module 115.

The position determination unit 116 determines the physical co-ordinates of the IMMC 101 within the healthcare facility. The physical co-ordinates of the IMMC 101 are used to determine the room in which the IMMC 101 is currently located in. The central control device 117 controls access into a medical container 102 housed in the IMMC 101. The central control device 117 tracks the movement of drug items in and out of the medical container 102. The timing module 114 maintains the schedule for drug administration of each patient. The tracking unit 113 records the time of all movements of drug items, in and out of the medical container 102. The correlating and inferring unit 118 determines whether a particular drug removed from the IMMC 101 to be administered or to be administered to a patient at the point-of-care or the operation theatre has any harmful interaction with other drugs previously administered to the patient. The “type of medical product” detection module 115 identifies the type of the drug or the class of the drug removed from the medical container 102. The name of the drug removed from the medical container 102 is obtained by reading the radio frequency identification (RFID) tag associated with the drug. After identifying the name of the drug, the “type of medical product” detection module 115 either looks up a shared medical database 105, or its local memory to identify the type of the drug. The information on the type of the drug, readily available in a pharmacopoeia in the medical database 105 indicates the type of medication such as anesthetic, antipyretic, antibiotic, antianemic, etc. The type of drug information includes the name of the manufacturer of the drug, the composition and concentration of the drug, etc.

The intelligence module 104 controls a display unit 109, an input unit 111 and an alarm 110. The intelligence module 104 may be a programmable micro-chip, a microcontroller, a personal computer, a hand-held computer, a terminal or a network computing device but is not restricted to be one of the above components. In one embodiment of the invention, the intelligence module 104 is located in the IMMC 101. In another embodiment of the invention, the intelligence module 104 is external to the IMMC 101 and remotely monitors and controls the IMMC 101. When used in a network relationship, the intelligence module 104 communicates with a network 112 using a communication module 107. The network 112 allows a user or system administrator to administrate, control and manage multiple IMMCs 101 in a healthcare facility. The network 112 interconnects a plurality of the IMMCs 101, the medical database 105 and the various hospital management systems 106. The hospital management system 106 may include but is not restricted to medication dispensing units or pharmacy, blood banks, health care staff and billing and administration staff. The network 112 may be a wireless network, a wired network or a combination thereof.

A radio frequency identification (RFID) module 103 generates a radio frequency identification (RFID) field (e.g. magnetic) within the medical container 102. The medical items are tagged with a RFID and registered with a medical database 105 prior to the additions of the items into the medical container 102. The intelligence module 104 communicates with the medical container 102 and the RFID module 103. As soon as a RFID tagged medical product is added into the medical container 102, the magnetic field recognizes the medical product and updates the inventory information of the medical container 102. The RFID mechanism thus assures accurate tracking of the medical items associated with the IMMC 101 and provides real time information regarding the IMMC 101 inventory. The inventory for the IMMC 101 reflects the items contained in the medical container 102. The medical products can be placed in any orientation inside the medical container 102 and comprise drug, non-drug products, disposable or surgical products, etc. The communication module 107 communicatively connects the intelligence module with other medical devices such as patient monitoring units commonly found in an operation theater. The patient monitoring units may directly feed the patient status into the intelligence module 104 or the medical database 105. The patient monitoring units may include but is not restricted to medical equipment such as electrocardiograph (ECG), electroencephalograph (EEG), electromyograph (EMG), automated ventilators and anesthesia equipment 108. Patient relevant information, inventories of all the IMMCs 101 within the hospital, general information, etc, are all accessed from the shared medical database 105. The medical database 105 can be accessed by a plurality of the IMMCs 101 as well as by the hospital management system 106. IMMC 101 accesses the medical database 105 through the communication module 107. The communications established by the communication module 107 may be wireless, wired or a combination thereof.

The IMMC 101 comprises an alarm 110 controlled by the intelligence module 104 that is enunciated when a failure is detected in drug administration and containment. The alarm serves to preclude any possible inadvertent mistakes, such as administration of wrong drugs, a wrong dosage or administration of a drug out of schedule. The alarm 110 could be one of a vocal alarm using a voice synthesizing unit, visual alarm using a display unit 109, beepers or buzzers or a combination thereof. The IMMC 101 has a display unit 109 for rendering visual data. The display unit 109 is in communication with the intelligence module 104 and is configured to provide a visual display corresponding to one of an action initiated by the intelligence module 104, status of the patient, inventory of the medical container 102, schedules of drug administration for patients, dosage of a drug for a particular patient, reason for an alarm, a thesaurus on all items, usage history, item history, user history, user data, item data, inventory data, a receptacle data, IMMC data, a receptacle inventory and IMMC inventory. In one embodiment of the invention, the display unit 109 may display the visual data in a split screen, whereby more than one data can be viewed simultaneously. The display unit 109 may be, but is not restricted to one of the following types: liquid crystal display (LCD), light emitting diode (LED), or touch screen.

A printer mechanism 125 is in communication with the intelligence module 104 and is configured to provide a visual print-out corresponding to one of an action initiated by the intelligence module, such as data regarding the status of the patient, inventory of the medical container, schedule of drug administration for patients, recommended dosage of a drug for a particular patient, reason for an alarm, a thesaurus on all items, usage history, item history, user history, user data, item data, inventory data, a receptacle data, IMMC data, a receptacle inventory, IMMC inventory, etc. An input unit 111 in communication with the intelligence module 104 is configured to receive user inputs concerning patient status, medical products, recommendation for alternative drugs, etc. The input unit 111 may include but is not restricted to a keypad, a touch screen, a voice input with a voice recognition unit, a magnetic reading device, a radio frequency identification reading device, a bar code reading device, a light pen, a keyboard, a mouse, a terminal, biometric readers, etc. The input unit 111 can also be used to alter the drug types, drug dosages, schedules, etc. of a patient. The input unit 111 is used to update the medical database 105 on the patient's current status, commands to archive records of discharged patients for future use, etc. The display unit 109 and the input unit 111 are located on the IMMC 101 at an ergonomically suitable location.

The medical database 105 is in communication with the intelligence module 104 through the communication module 107 of the IMMC 101. The medical database 105 consists of electronic medical records 124 and medical data 123. Electronic medical records 124 comprises the medical profile of the patient such as the ailment the patient is suffering from, the medications prescribed, the schedule at which the medicines are to be consumed, medicines the patient is allergic to, the room number the patient is admitted to, previous record of the patient, prior adverse reactions and allergies, a database of adverse drug interactions, drug usage history, time of administration of drugs, etc. Medical data 123 includes information on drug availability, RFID tagging data or RFID allocation data, pharmacopoeia and information on the medical products present in the medical container 102. The medical database 105 is a shared database, thus the hospital management system 106 can access, update or alter the medical database 105 via the IMMCs 101. The hospital management system 106 is updated at regular intervals on information such as inventory of all IMMCs 101, medical conditions of the patients, progress reports of all the patients, etc. The hospital management system 106 comprises a network 112 of all units in a hospital such as medication dispensing units, blood banks, health care staff, billing and administration staff, and the like.

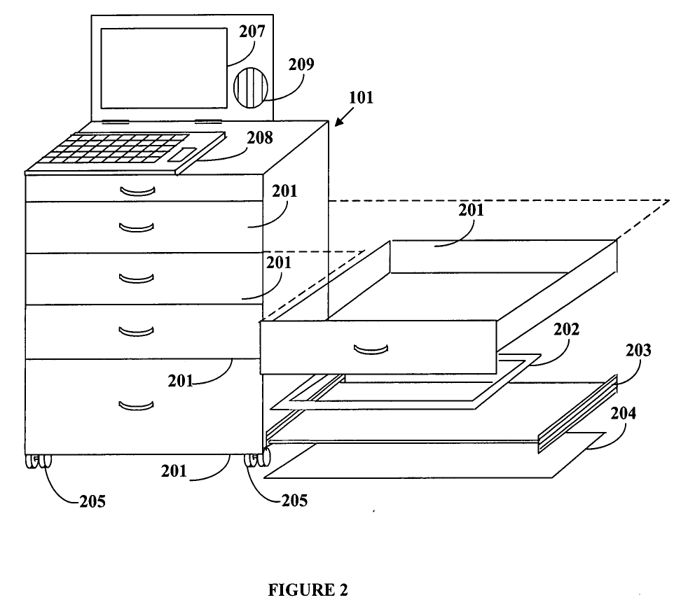

FIG. 2 illustrates an exemplary representation of the IMMC 101. In one embodiment, three item-containing drawers 201 are illustrated, although any number of drawers 201 may be utilized, and the number of drawers 201 would not affect the functionality of the IMMC 101. Further, for easy movement of the IMMC 101, the IMMC 101 comprises wheels 205. In this embodiment, the display unit 109 is a liquid crystal display screen 207 and the input unit Ill is a keypad 208. In this embodiment, the liquid crystal display screen 207 and the keypad 208 are positioned as shown in FIG. 2. An audio speaker 209 is used in an embodiment for rendering vocal alarms. A passive signal receiving mechanism is in communication with the receptacles and receives signals emanating from the signal emitting mechanisms. The intelligence module is in communication with the signal receiving mechanism and is able to initiate various actions based upon the content of the signals received by the signal receiving mechanism. The signal emitting mechanisms are radio frequency identification (RFID) transponders or tags. Each of these RFID tags are attached to or associated with an individual medical product in the IMMC 101. Further, each of the RFID tags emit a signal, which is unique to the medical product to which the RFID tag is attached to or associated with. In one embodiment of the invention, the signal receiving mechanism is an antenna 202, which is capable of receiving the radio frequency signals emanating from the RFID tags. In one embodiment, each antenna 202 is positioned adjacent the drawer 201 by a central panel element 203. The antenna 202 is positioned upon the central panel element 203 when the antenna 202 is below the drawer 201. On a side opposite the antenna 202 of the central panel element 203, a shielding element 204 is attached. The shielding element 204 prevents signals from passing there-through. This prevents medical products or items in other drawers 201 located above or below the object drawer 201 from being read during the reading process. This prevents confusion by the central control device 117 due to reading the RFID tags in drawers 201 other than the object drawer 201 and isolation of each individual drawer 201. Each drawer 201 may have a shielding element 204 associated with it, and the IMMC 101 may also have a shielding element 204.

While a single antenna 202 may be placed below the drawer 201 as illustrated in FIG. 2, in another embodiment, two antennas 202 are used. Of the two antennas, one antenna 202 is positioned immediately above the drawer 201, and one antenna 202 immediately below the drawer 201. When the drawer 201 is in the closed position, the medical products (and subsequently the RFID tags) are positioned in the medical container 102, such that they are located in the antenna field. The RFID tags are energized by the antenna field and emit a radio frequency signal corresponding to its unique identification, typically an identification number. The signals are picked up by the antenna 202 and communicated to the intelligence module 104. While the signals emanating from the signal emitting mechanisms or the RFID tags typically have a characteristic unique to a specific medical product, it is also envisioned that the signal emitting mechanisms may emit signals unique to a group set, or other association of multiple medical products. In addition, in this embodiment, the two antennas 202 are positioned such that they are dedicated to receive signals emanating from an assigned receptacle or drawer 201. This arrangement allows the signal receiving mechanism or the antenna 202 to passively receive signals, as opposed to necessitating the specific movement of a medical product across a stationary reading device.

The signals received from the RFID tags of the medical products are detected by a signal reader mechanism. The signal reader mechanism, i.e., the RFID reader, is a part of the RFID module 103. The signal reader mechanism decodes the signal, and communicates the decoded signal to the intelligence module 104 via an input/output mechanism 119. The input/output mechanism 119 translates the output signals from signal reader mechanism into digital output signals. The intelligence module 104 is in communication with the input/output mechanism 119. The intelligence module 104 receives, processes, and transmits signals, as well as initiates actions, based upon the digital output signals received from the input/output mechanism 119.

In another embodiment, the IMMC 101 may include multiple signal receiving mechanisms in order to improve the coverage of the medical container 102 to receive signals from the RFID tagged medical products. Further, the signal receiving mechanisms may move in defined paths within the medical container 102 to further enhance the sensitivity or coverage to receive the signals from the RFID tagged medical products.

The IMMC 101 also includes a power control module 120 which is in communication with the input/output mechanism 119. This power control module 120 provides specified power outputs at specified levels to the various components of the IMMC 101. Further, the power control module 120 may be operated or activated by a single power switch 121. Therefore, a user need only operate a single power switch 121 to power all the various components of the IMMC 101. The IMMC 101 may also include a back-up power module 122 in communication with the input/output mechanism 119 in order to supply power in the event of an electrical power failure.

In another embodiment, the IMMC 101 includes a switch mechanism which is in operable communication with the receptacle or drawer 201. As a user opens a particular drawer 201, the switch mechanism moves to an open position and indicates the central control device 117 via the input/output mechanism 119 that it has been opened. The central control device 117, or the software contained therein, then sends signals to the RFID module 103 to begin reading input from the antennas 202 associated with the particular drawer 201 that has been opened.

The IMMC 101 includes a lock mechanism associated with each drawer 201. These lock mechanisms are in communication with the central control device 117 via the input/output mechanism 119 and serve to prevent access to the drawer 201 based upon action signals sent by central control device 117. In one embodiment, the lock mechanisms are magnetic locks, which based upon signals received from the central control device 117, may activate and attract a part of the drawer 201. This would prevent the drawer 201 from sliding and providing access to an unauthorized user. This lock mechanism, together with the user authorization, creates a security system which prevents any unauthorized access to the IMMC 101. It is also envisioned that a physical master key is provided and capable of allowing authorized access to the IMMC 101 during a power outage or other emergency situation. In another embodiment, the IMMC 101 may be a miniaturized table-top cart. In yet another embodiment the IMMC 101 may be used in hospital wards for post operative care.

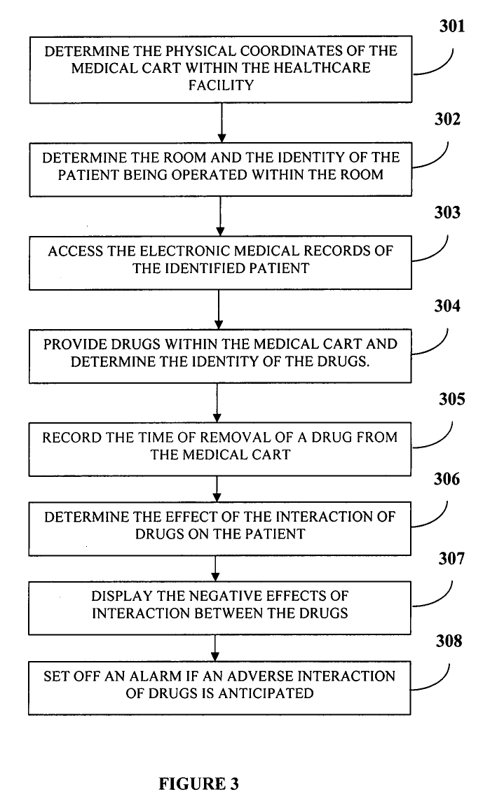

FIG. 3 exemplarily illustrates the method of monitoring, control and containment of medical products in an operating room in a health care facility. The physical co-ordinates of the IMMC 101 are determined 301 using a position determination unit 116. The physical co-ordinates of the IMMC 101 determine the room the IMMC 101 is currently in 302 within the healthcare facility. Subsequently, by looking up the medical database 105, the position determination unit 116 determines the identity of the patient 302 located in the room. Once the identity of the patient is determined, the electronic medical records 124 of the identified patient are accessed 303. The IMMC 101 provides access to the contents 304 of the IMMC 101 to the authorized staff. Whenever a drug is removed from the medical container 102, the IMMC 101 determines the identity of the drug 304 that has been removed. The IMMC 101 also records the time at which a drug is removed 305 from the IMMC 101. In addition to tracking the drugs, the IMMC 101 determines the effect of the interaction of drugs on the patient 306. The effect of interaction is determined 306 using information on the identity of drug removed, the time of removal of the drug and the pharmacopoeia in the medical database 105. The identity and time of removal of the drug are compared with the medical profile of the patient available in the electronic medical records 124 of the patient. The information on the amount of drug to be taken out of the medical container 102 and also the time at which the drug is to be administered are extracted from the medical profile of the patient available in the shared medical database 105. The drugs, dosage of the drugs and schedule of administration of the drugs are compared with the medical profile of the patient, to determine the effect of the drugs on the patient. The interaction of the drugs with one another that have been removed from the medical container 102 and administered to the patient is also determined. Any negative effects of interaction between the drugs may be displayed 307 on the display unit 109 either in text form or in symbolic form. The effects of interaction of the drugs on the patient can also be rendered verbally using a voice synthesizing unit. The IMMC 101 may enunciate an alarm if an adverse interaction of drugs is anticipated 308.

In another embodiment of the invention, the medical apparatuses and the staff working in the hospital are RFIG tagged. In another embodiment of the invention, the patient may be RFID tagged. An RFID magnetic field may be emanated from the IMMC 101 at low energy levels. The RFID magnetic field is emanated from an external RFID module attached to the IMMC 101. The external RFID module is different from the RFID module 103 used for generating a RFID magnetic field within the medical container 102. The external RFID magnetic field is used only to recognize the RFID tags associated with either the staff or the patient in the vicinity of the IMMC 101 and thereby establishes the identity of the staff and the patients. The IMMC 101 includes an inherent safety system for preventing unauthorized access to the medical container 102. Only the authorized RFID tagged healthcare staff may be provided access to the medical container 102. When a healthcare staff associated with a RFID tag is in the vicinity of the external RFID magnetic field of the IMMC 101, the medical container 102 may unlock itself. The medical container 102 further may have a shielding element 204 associated with it. The shielding element 204 ensures that the magnetic field and the signals emanating from within the medical container 102 do not pass through the medical container 102. Thus, the external and internal RFID magnetic fields do not interfere with each other. For example, when the IMMC 101 is transported to another operation theatre and near a patient, the external magnetic field detects the RFID tag associated with the patient and identifies the patient. After identifying the patient, the electronic medical records 124 of the patient is immediately accessed from the medical database 105. Consider another example: the healthcare staff associated with the IMMC 101 leaves the IMMC 101 stationary in a hospital ward to attend to other businesses. The external RFID magnetic field now does not detect any RFID tag associated with the healthcare staff, and the medical container 102 automatically locks itself. When the healthcare staff returns to the IMMC 101, the RFID tag associated with the staff falls under the external RFID magnetic field, and the medical container 102 unlocks itself.

In another embodiment, the IMMC 101 checks the patient's electronic medical records 124 to determine whether a drug being removed from the IMMC 101 for administration to the patient, has any adverse effect as a result of a negative interaction with any drug previously consumed by the patient. The IMMC 101 alarms the healthcare staff if a negative interaction is anticipated. The IMMC 101 also alarms the healthcare staff if a drug may not have the desired effect on the patient. The drug interactions may be determined by looking up the database of drug interactions in the electronic medical records 124. The IMMC 101 inventories the medical container 102 at predetermined and frequent intervals. The IMMC 101 inventories as soon as a drug or medical item is removed from the medical container 102. By comparing the inventory of the medial container 102 before and after the removal of a drug, the IMMC 101 recognizes the identity of the drug removed from the medical container 102. The IMMC 101 also signals an immediate alarm if the drug being removed at a close proximity of the patient has any uncalled health effects on the patient. The drugs removed from IMMC 101 are verified with the electronic medical records 124 of the patient to determine that the drug removed is prescribed and does not cause any adverse effect on the patient.

For example, consider a patient who may be taking a statin drug such as Zocor or Mevacor which reduce cholesterol levels. Antibiotics such as erythromycin or biaxin interact adversely with Zocor or Mevacor and the interactions may range from muscle pain, muscle damage, to pancreatic or acute kidney failure. If such antibiotics are prescribed and the healthcare staff removes the prescribed antibiotic to administer to the patient, the IMMC 101 determines that the patient is using the statin drug Zocor, by accessing the electronic medical records 124 of the patient. The IMMC 101 immediately warns the healthcare staff of the anticipated drug interaction.

Consider another example: the patient being treated may regularly take an analgesic drug similar to the one prescribed for pre or post surgical pain alleviation. The patient may be immune to the prescribed analgesic due to the regular intake of the analgesic, and as a consequence may feel the pain during the surgery even after the administration of the analgesic. The IMMC 101 looks up the electronic medical records 124 of the patient and determines that the patient had a habit of taking similar analgesics. The IMMC 101 thereafter warns the healthcare staff that the prescribed drug is unsuitable for administration to the patient.

In yet another embodiment, the IMMC 101 compares the drug name identified by the RFID tag removed from the medical container 102, with the drug name prescribed or scheduled to be removed from the medical container 102 and administered to the patient. When a drug is removed from the medical container 102, the intelligence module 104 looks up the electronic medical record 124 of the patient and extracts information on the amount of drug to be taken out of the medical container 102 and also the time at which the drug is to be administered. The IMMC 101 sets off an alarm 110 if the drug name read by the RFID tag does not match with the drug name that is prescribed or scheduled to be taken out of the medical container 102. The IMMC 101 further indicates the allergies of a patient. When a drug is taken out of the medical container 102, the IMMC 101 warns the healthcare staff immediately using the alarm 110 if the patient is allergic to the drug that has been removed from the IMMC 101. The IMMC 101 associated with the patient may also notify the healthcare staff if a particular drug administration schedule of a patient has been missed or delayed. In another embodiment, the IMMC 101 lists the drugs, drug dosages and drug administration schedules of all the patients associated with the IMMC 101 and displays the list on the display unit 109. For example, when the IMMC 101 approaches a patient in a hospital ward, the IMMC 101 determines the identity of the patient by reading the RFID tag associated with the patient. Then, the IMMC 101 lists the drugs, drug dosages and drug administration schedules of the identified patient and displays the list on the display unit 109. When the schedule list indicates that a drug administration schedule is due, the healthcare staff remove the drugs from the medical container 102 and administer the drugs to the patient. In the process, the IMMC 101 determines the drugs removed from the IMMC 101 for administration and compares with the list of drugs and drug schedules of the patient. If a match is established, the IMMC 101 subsequently cancels the particular drug schedule in its list.

Another embodiment of the invention ensures the availability of drugs in an operating room in real time using the IMMC 101. The physical coordinates of the IMMC 101 is determined every time the IMMC 101 is moved and brought to a stationary position. The movement of the IMMC 101 may be detected using an accelerometer residing within the IMMC 101. The accelerometer may signal the movements of the IMMC 101 to the intelligence module 104. The physical co-ordinates of the IMMC 101 determine the identity of the room within the healthcare facility and the identity of the patient being operated within the room. After a medical practitioner completes a medical diagnosis of a patient, the drug requirements of the patient are inputted into the IMMC 101. The drug requirements may be pre-operative, required during surgery, or post operative, or a combination thereof. A minimum drug storage threshold level is set for all the drugs in the IMMC 101 needed for an operation on a patient. The threshold level for the drugs is set using information available in the electronic medical records 124 and as required for the patient during the operation. In one embodiment of the invention, the drug storage threshold level can be set for post operative needs. In case a drug needed for an operation reaches the minimum threshold or reaches the minimum threshold during post operative care, an alarm message is transmitted by the IMMC 101 to the pharmacy via the network 112 in real time to immediately replenish the stock of the drug(s) given the emergency environment in the operating room.

Consider an emergency situation where a prescribed drug has to be immediately administered to a patient. The healthcare staff realize that the prescribed drug in the IMMC 101 associated with the patient has been depleted as a result of a delay caused by the pharmacy in replenishing the drug, even after alarming the pharmacy regarding the shortage. Resorting to other IMMCs 101 nearby may not help as other carts 101 may not necessarily have the prescribed drug in their inventory. In such a situation, the healthcare staff can input the name of the prescribed drug into the IMMC 101. In return the IMMC 101 recommends the use of a drug available in the medical container 102 that is closely related to the type of the prescribed drug by looking up the pharmacopoeia in the medical database 105. The IMMC 101, using its intelligence module 104, ensures that the recommended alternative drug is safe and effective and does not cause any adverse effects on the patient by verifying with the patient's electronic medical records 124.

In another embodiment of the invention, the IMMC 101 sends a warning notice to the physician and the pharmacy if the drug stored in the medical container 102 reaches or is past its expiry date. The information on the manufacturing date of the drugs can be included in the RFID tags associated with the drugs. Alternatively, the manufacturing date may be updated in the medical database 105 when a fresh stock of drugs is received. The medical container 102 housing the drugs is in communication with the medical database 105 and the pharmacy division. The medical container 102 compares the RFID tags of each of the drugs in its inventory against the RFID tagging data in the medical database 105 and their associated expiry date information. Whenever the stock of the drug(s) reaches its expiry date, or is close to its expiry date, or falls below the threshold quantity level, the IMMC 101 transmits an alarm to the physician and the pharmacy to replenish the drug(s). The threshold quantity level and the minimum period before the expiry dates are preset in the intelligence module 104.

In another embodiment, the IMMC 101 determines the exact position of a drug within its medical container 102 when a search query on the drug is inputted. A result of the search on the position of the drug is displayed on the display unit 109. The result displayed indicates the receptacle or drawer 201 in which the drug may be found. The IMMC 101 may also determine the presence of the drug that is being searched in other IMMCs 101. The network 112 interconnects all the IMMCs 101 within the healthcare facility. The IMMC 101 communicates with the network by using the communication module 107. Each individual IMMC 101 may be associated with a unique number. A user may input the unique number of any other IMMC 101 into the IMMC 101 being used and the intelligence module 104 determines the location of the other IMMCs within the health care facility by using the network 112. The unique numbers of other IMMCs 101 are dialed by the communication module 107 of the IMMC 101 being used to communicate with other IMMCs 101 and determine the inventory of other IMMCs 101. The locations of other IMMCs 101 and their inventories may be displayed on the display unit 109. The hospital management system 106 may access the IMMCs 101 using the unique numbers associated with the IMMCs 101 and determine the locations of all the IMMCs 101 within the hospital, inventories of all the IMMCs 101 and any information associated with the IMMCs 101. The hospital management system 106 is connected to the network 112 and any general computer can be used to access the network 112.

It will be readily apparent to a person with skill in the art that the various methods and algorithms described herein may be implemented as computer readable medium, e.g., appropriately programmed general purpose computers and computing devices. Typically a processor, for example, one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In some embodiments, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors, or like devices. The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as object code. A computer program product comprising computer executable instructions embodied in a computer-readable medium comprises computer parsable codes for the implementation of the processes of various embodiments.

Where databases are described, such as the medical database 105, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel.®™, Pentium.®™, or Centrino.™ processor, that are adapted to communicate with the computer. Any number and type of machines may be in communication with the computer.

In one embodiment of the invention, the intelligence module resides within IMMC 101. In another embodiment of the invention, the intelligence module is external to the IMMC 101 and remotely monitors and controls the IMMC 101. When used in a network relationship, the intelligence module 104 communicates with a network 112 using a communication module 107.

The present invention has been described in the context of tracking medical products including drugs, non-drug products, surgical and other medical instruments, etc. However, it will be appreciated by those skilled in the art that the same system for tracking medical drugs and items may be extended to track any form of tangible items that can be associated with RFID tags. The items may include objects, supplies, assets, instruments, etc. The invention can be used in a variety of inventory tracking and asset management systems.

The present invention has been described to operate using a radio frequency identification system. However, it will be appreciated by persons skilled in the art that other wireless data gathering and communications platforms and protocols can be used in connection with the presently-invented system. All such platforms, protocols and systems may be used to effectively implement this system.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim

1. A system for monitoring, control and containment of medical products in a health care facility, comprising:
an intelligent medical material cart comprising an enclosed medical container, wherein said medical container comprises a plurality of receptacles for storing a plurality of medical products;
an interactive intelligence module integrated with said intelligent medical material cart for performing intelligent drug monitoring, control and administration, comprising:
a position determination unit for determining the physical coordinates of the intelligent medical material cart;
a central control device for controlling access of the medical products into the medical container and for tracking the movement of said medical products in and out of the medical container;
a timing module for maintaining prescribed schedules for drug administration of patients;
a tracking module for recording the time of movements of said medical products, in and out of said medical container; and
a correlating and inferring unit for determining whether a particular medical product removed from the intelligent medical material cart to be administered to a patient has an adverse interaction with other drugs previously administered or to be administered to the patient.
a radio frequency identification module for generating a radio frequency identification field in and around the medical container, wherein the radio frequency identification field is used for tracking radio frequency identification tagged medical products in the medical container; and
an alarm controlled by said intelligence module that enunciates when a failure is detected in the medical product administration and containment.

2. The system of claim 1, further comprises a communication module to communicatively connect the intelligence module with other medical devices in said health care facility.

3. The system of claim 1, further comprises a medical database in communication with said intelligent medical material cart for providing information about the medical product in the medical container, and the electronic medical record of the patient.

4. The system of claim 1, further comprising an input/output mechanism for translating output signals from said radio frequency identification module into digital output signals, wherein said digital output signals are compatible with said intelligence module.

5. The system of claim 1, wherein said intelligence module is one of a programmable microchip, a microcontroller, a personal computer, a hand-held computer, a terminal and a networked computing device.

6. The system of claim 1, wherein said alarm is further used for evasion of inadvertent medication errors, such as an incorrect medical product, an incorrect dosage, an administration of a drug out of schedule, said alarm including but not restricted to vocal alarm using a voice synthesizing unit, visual alarm using a display unit, beepers or buzzers or any combination thereof.

7. The system of claim 1, further comprising a display unit in communication with the intelligence module and configured to provide a visual display to a user corresponding to one of an action initiated by the intelligence module, data regarding the status of the patient, inventory of said medical container, schedule of the medical product administration for patients, recommended dosage of a medical product for a particular patient, reason for an alarm, a thesaurus on all items, usage history, an item history, user history, user data, item data, inventory data, a receptacle data, intelligent medical material cart data, a receptacle inventory and intelligent medical material cart inventory.

8. The system of claim 1, further comprising a printer mechanism in communication with the intelligence module and configured to provide a visual printout corresponding to one of an action initiated by the intelligence module, data regarding the status of the patient, inventory of said medical container, schedule of medical product administration for patients, recommended dosage of a medical product for a particular patient, reason for an alarm, a thesaurus on all items, usage history, item history, user history, user data, item data, inventory data, a receptacle data, intelligent medical material cart data, a receptacle inventory and intelligent medical material cart inventory.

9. The system of claim 1, further comprising an input unit in communication with the intelligence module and configured to receive user inputs concerning patient status, medical products, recommendation for alternative medical products, etc.

10. The system of claim 9, wherein said input unit is one of a keypad, touch screen, voice input with a voice recognition unit, a personal computing device, a hand-held computing device, a magnetic reading device, a radio frequency identification reading device, a bar code reading device, a light pen, a keyboard, a mouse, a terminal, and a biometric reader.

11. The system of claim 3, wherein said medical database comprises electronic medical records and medical data.

12. The system of claim 11, wherein said electronic medical records consist of the medical profile of the patient such as the ailment the patient is suffering from, the medications prescribed, the schedule at which the medicines are to be consumed, drugs the patient is allergic to, room number the patient is admitted in, drugs administered to the patient in the past and the time of administration, and previous medical records of the patient, prior adverse reactions and allergies, a database of adverse drug interactions, drug usage history and time of administration of drugs.

13. The system of claim 11, wherein said medical data comprises information on drug availability, radio frequency identification tagging data or radio frequency identification allocation data and pharmacopoeia.

14. The system of claim 1, further comprising a network, wherein said network interconnects a plurality of intelligent medical material carts, the hospital management system, and the database.

15. The system of claim 1, further comprising a type of medical product detection module for identifying the type of medical product removed from the medical container.

16. A method of monitoring, control and containment of medical materials in a health care facility comprises the steps of:
determining the physical coordinates of a intelligent medical material cart using a position determination unit;
determining the room and the identity of the patient within said room based on said physical coordinates of said intelligent medical material cart using position determination unit within the health care facility;
accessing the electronic medical records of the identified patient from a medical database;
providing medical products stored within said intelligent medical material cart to the patient, wherein if a medical product is removed from the medical container, the intelligent medical material cart determines the identity of the medical product that has been removed based on radio frequency identification mechanism, and records the time at which the medical product is removed from the intelligent medical material cart;
determining the effect of the interaction of drugs on the patient, based on said identity of medical product removed, the time of removal of the medical product and the pharmacopoeia in the medical database with reference to the medical profile of the patient in said electronic medical records;
displaying said effect of the interaction of the medical product; and
enunciating an alarm if an adverse interaction of the medical product is anticipated.

17. The method of claim 16, wherein said medical database is in communication with the intelligence module.

18. The method of claim 16, wherein said identity of the medical products removed from the intelligent medical material cart is determined through a radio frequency identification module, and further wherein said medical products are individually radio frequency identification tagged and registered in the medical database.

19. The method of claim 16, wherein the interaction of medical product is determined by the intelligence unit based on the information available in a pharmacopoeia of the medical database.

20. The method of claim 16, wherein the medical products are stored in a medical container having a magnetic field, and further wherein a signal reader mechanism reads the signals transmitted by the radio frequency identification tags and records the identity of the medical products, time and the date at which the medical products were moved from the medical container.

21. The method of claim 16, wherein the medical apparatuses and the staff working in the hospital are tagged using radio frequency identification tags.

22. The method of claim 16, wherein the patient is provided with a radio frequency identification tag comprising the identity of the patient.

23. The method of claim 16, wherein when a medical product is removed from the medical container, the intelligence module looks up the electronic medical record of the patient, and extracts information on the amount of medical product to be taken out of the medical container and also the time at which the medical product is to be administered.

24. The method of claim 16, wherein the intelligence module compares the patient's electronic medical record with the medical product being removed such that said drug does not have any untoward effect on the previously consumed drug.

25. The method of claim 16, wherein the intelligent medical material cart sends a warning to the healthcare staff if the medical product being removed from the medical container may have an adverse effect on the patient.

26. The method of claim 16, wherein the name of the medical product being removed from the medical container is obtained by reading the radio frequency identification tag associated with said medical product.

27. The method of claim 16, further comprises comparing the medical product name identified by the radio frequency identification tag removed from the medical container with the drug name authorized or scheduled to be removed from the medical container, wherein the intelligent medical material cart sets off an alarm if the medical product name read by the radio frequency identification tag does not match with the drug name that's authorized to be taken out of the medical container.

28. The method of claim 16, further comprises the indication of allergies of the patient.

29. The method of claim 16, wherein when a medical product is taken out of the medical container, enunciating an alarm if the patient is allergic to said medical product.

30. The method of claim 17, wherein said communication may be through wireless, wired networks, or a combination and further wherein the communications are handled by a communication module.

31. The method of claim 16, further comprises the step of ensuring the availability of drugs in a medical operation theatre in real time using the intelligent medical material cart.

32. The method of claim 31, further comprises the step of inputting the medical product requirements of the patient in said intelligent medical material cart, and setting minimum medical product storage threshold levels for said medical product required for a particular procedure being undertaken on the patient.

33. The method of claim 31, wherein said intelligent medical material cart sends an alarm to the pharmacy in real time to replenish the stock of a medical product if said medical product is removed from the intelligent medical material cart and consequently the stock of the medical product falls below the set threshold.

34. The method of claim 31, wherein the threshold level for the medical product is set depending upon the electronic medical records of the patient and as required by the patient during an operation.

35. The method of claim 31, wherein the intelligent medical material cart sends a warning notice to the physician if the medical product stored in the container reaches its expiry date.

36. The method of claim 31, wherein the medical container housing the medical product is in communication with the pharmacy division and further wherein the intelligent medical material cart sends an alarm to the physician and the pharmacy to replenish the medical product whenever the stock of the medical product falls below the threshold level or reaches its expiry date.

37. The method of claim 16, further comprising the step of updating a hospital management system on information such as inventory of all said intelligent medical material carts, status of all the patients, wherein the hospital management system comprises a network of all units in a hospital such as medication dispensing units, blood banks, health care staff, billing and administration staff.

38. A computer program product comprising computer executable instructions embodied in a computer-readable medium, said computer program product comprising:
a first computer parsable program code for determining the physical coordinates of a intelligent medical material cart using a position determination unit;
a second computer parsable program code for determining the room, and determining the identity of the patient in said room based on said physical coordinates of said intelligent medical material cart using position determination unit within the hospital;
a third computer parsable program code for accessing the electronic medical records of the identified patient from a medical database;
a fourth computer parsable program code for providing medical product to the patient stored within said intelligent medical material cart, wherein if a medical product is removed from the medical container, the intelligent medical material cart determines the identity of the medical product that has been removed based on radio frequency identification mechanism, and records the time at which a medical product is removed from the intelligent medical material cart;
a fifth computer parsable program code for determining the effect of the interaction of the medical product on the patient, based on said identity of medical product removed and the time of removal of the medical product with reference to the medical profile of the patient in said electronic medical records;
a sixth computer parsable program code for displaying said effect of the interaction of medical product; and
a seventh computer parsable program code for setting off an alarm if an adverse interaction of medical product is anticipated.
